(19) United States
(12) Patent Application Publication
(10) Pub. No.: US 2026/0218083 A1
(43) Pub. Date: Jul. 30, 2026

(54) CLEANING COMPOSITION FOR METAL ARTICLES

(71) Applicant: KAO CORPORATION, Tokyo (JP)

(72) Inventors: Genki KUBO, Wakayama-shi (JP); Jun NAGANUMA, Wakayama-shi (JP)

(73) Assignee: KAO CORPORATION, Tokyo (JP)

(21) Appl. No.: 19/145,699

(22) PCT Filed: Dec. 26, 2023
(86) PCT No.: PCT/JP2023/046684

§ 371 Date: Jul. 3, 2025

(30) Foreign Application Priority Data
Jan. 5, 2023 (JP) 2023-000672

(51) Int. Cl. C11D 1/722; C11D 1/825; C11D 3/20; C11D 3/30

(52) U.S. Cl. CPC C11D 1/722; C11D 1/8255; C11D 3/2082; C11D 3/30; C11D 2111/16

(57) ABSTRACT

The present invention is a cleaning composition for metal articles including an amine (component A) represented by a general formula (I), a nonionic surfactant (component B) represented by a general formula (II), a nitrogen-containing nonionic surfactant (component C) represented by a general formula (III), and water (component D), the cleaning composition having a pH of 7.1 or more. According to the present invention, it is possible to provide a cleaning composition for metal articles that has sufficient cleaning performance at ambient temperature and excellent drying properties at ambient temperature and thus can contribute to reducing the burden on the environment.

### TECHNICAL FIELD

The present invention relates to a cleaning composition for metal articles.

### BACKGROUND ART

Metals including iron, copper, and aluminum are processed and used in industrial products in various fields. Various detergents are used for the purpose of removing stains adhering to the surface of such metal products during processing and at the time of finishing. The function required of detergents is to purify the surface of metals. However, metals are oxidized by oxygen in the air, easily corrode, and thus are generally subjected to anticorrosive treatment such as application of anticorrosive agent after being cleaned. It is required to remove the unnecessary anticorrosive agent from the metal surface and to purify the metal surface again immediately before the work in the next process, and this increases the number of work processes. In such a case, the work efficiency can be improved by using a detergent having anticorrosive performance in addition to high cleaning performance as a detergent (for example, JP-A-2020-117644).

### SUMMARY OF THE INVENTION

The present invention is a cleaning composition for metal articles including:
an amine (component A) represented by a general formula (I):

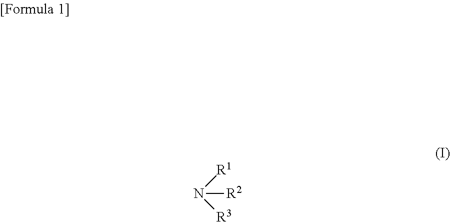

(in the general formula (I), R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group);
a nonionic surfactant (component B) represented by
a general formula (II): R⁴—O—{(EO)n¹/(PO)m¹}—H (II)
(in the general formula (II), R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement);
a nitrogen-containing nonionic surfactant (component C) represented by a general formula (III):

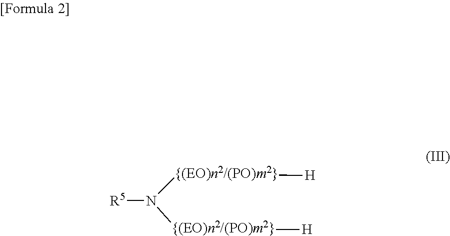

(in the general formula (III), R⁵ represents an alkyl group or a cycloalkyl group having 8 or more and 18 or less carbon atoms on average, EO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the EO added shown in { } is optionally a random arrangement or a block arrangement); and water (component D), the cleaning composition having a pH of 7.1 or more.

Also, the present invention is a method of cleaning a metal article, the method including a cleaning step of cleaning a metal article using the cleaning composition for metal articles.

Also, the present invention is a method of cleaning a metal article, the method including a drying step after the cleaning step, the drying step of drying the metal article while removing excess of the cleaning composition for metal articles adhering to the metal article by air blowing.

Also, the present invention is a processing oil removing composition for metal articles including:
an amine (component A) represented by a general formula (I):

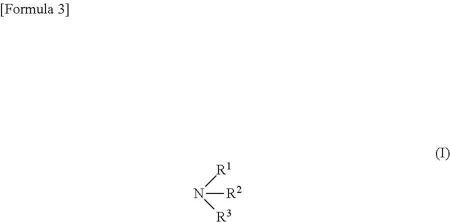

(in the general formula (I), R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group);
a nonionic surfactant (component B) represented by
a general formula (II): R⁴—O—{(EO)n¹/(PO)m¹}—H (II)
(in the general formula (II), R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement);
a nitrogen-containing nonionic surfactant (component C) represented by a general formula (III):

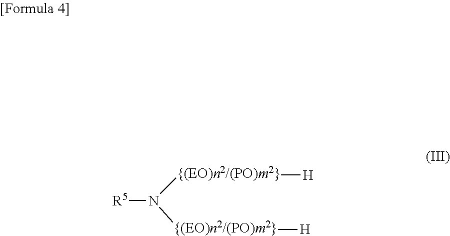

(in the general formula (III), R⁵ represents an alkyl group or a cycloalkyl group having 8 or more and 18 or less carbon atoms on average, EO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the EO added shown in { } is optionally a random arrangement or a block arrangement); and water (component D), the processing oil removing composition having a pH of 7.1 or more.

Also, the present invention is a method of removing a processing oil from a metal article, the method including a removal step of removing a processing oil from a metal article, the processing oil that adheres to the metal article in production of the metal article, using the processing oil removing composition for metal articles.

### DETAILED DESCRIPTION OF THE INVENTION

Conventional cleaning agents are heated to about 60° C. or more for use from the viewpoint of cleaning performance. Heating the cleaning agents to a predetermined temperature requires great energy cost, and there is room for improvement from the viewpoint of reducing the burden on the environment.

A metal article after cleaning with a conventional cleaning agent is generally subjected to a drying step of drying the metal article while an excess of the cleaning agent is removed by air blowing or the like at a high temperature of about 80° C. or more. The drying step of drying a conventional cleaning agent also requires great energy cost, and in this respect, there is room for improvement from the viewpoint of reducing the burden on the environment.

An object of the present invention is to provide a cleaning composition for metal articles that has sufficient cleaning performance at ambient temperature and excellent drying properties at ambient temperature and thus can contribute to reducing the burden on the environment, a method of cleaning a metal article using the cleaning composition for metal articles, a processing oil removing composition for metal articles, and a method of removing a processing oil from a metal article.

The present invention is a cleaning composition for metal articles including:
an amine (component A) represented by a general formula (I):

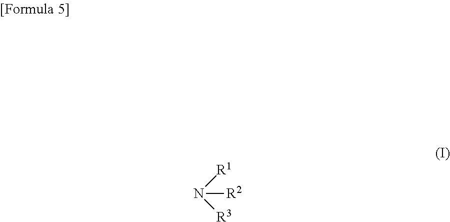

(in the general formula (I), R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group);
a nonionic surfactant (component B) represented by
a general formula (II): R⁴—O—{(EO)n¹/(PO)m¹}—H (II)
(in the general formula (II), R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement);
a nitrogen-containing nonionic surfactant (component C) represented by a general formula (III):

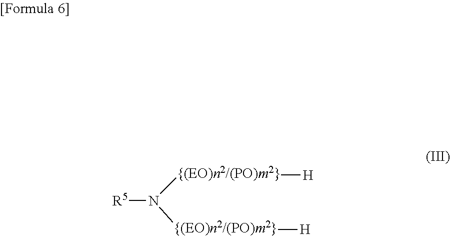

(in the general formula (III), R⁵ represents an alkyl group or a cycloalkyl group having 8 or more and 18 or less carbon atoms on average, EO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the EO added shown in { } is optionally a random arrangement or a block arrangement); and water (component D), the cleaning composition having a pH of 7.1 or more.

Also, the present invention is a method of cleaning a metal article, the method including a cleaning step of cleaning a metal article using the cleaning composition for metal articles.

Also, the present invention is a method of cleaning a metal article, the method including a drying step after the cleaning step, the drying step of drying the metal article while removing excess of the cleaning composition for metal articles adhering to the metal article by air blowing.

Also, the present invention is a processing oil removing composition for metal articles including:
an amine (component A) represented by a general formula (I):

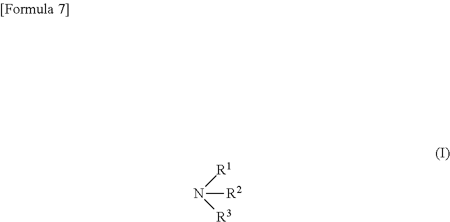

(in the general formula (I), R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group);
a nonionic surfactant (component B) represented by
a general formula (II): R⁴—O—{(EO)n¹/(PO)m¹}—H (II)
(in the general formula (II), R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement);
a nitrogen-containing nonionic surfactant (component C) represented by a general formula (III):

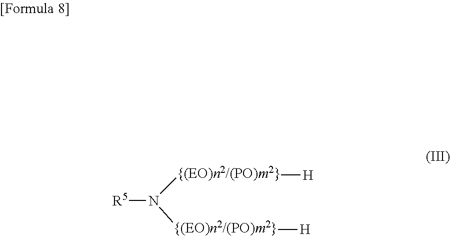

(in the general formula (III), R⁵ represents an alkyl group or a cycloalkyl group having 8 or more and 18 or less carbon atoms on average, EO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the EO added shown in { } is optionally a random arrangement or a block arrangement); and water (component D), the processing oil removing composition having a pH of 7.1 or more.

Also, the present invention is a method of removing a processing oil from a metal article, the method including a removal step of removing a processing oil from a metal article, the processing oil that adheres to the metal article in production of the metal article, using the processing oil removing composition for metal articles.

According to the present invention, it is possible to provide a cleaning composition for metal articles that has sufficient cleaning performance at ambient temperature and excellent drying properties at ambient temperature and thus can contribute to reducing the burden on the environment, a method of cleaning a metal article using the cleaning composition for metal articles, a processing oil removing composition for metal articles, and a method of removing a processing oil from a metal article.

Hereinbelow, an embodiment of the present invention will be described.

### <Cleaning Composition for Metal Articles>

A cleaning composition for metal articles according to the present embodiment (hereinafter also simply referred to as a cleaning composition) including:
an amine (component A) represented by a general formula (I):

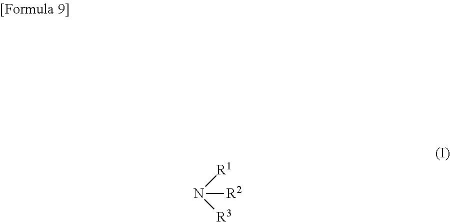

(in the general formula (I), R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group);
a nonionic surfactant (component B) represented by
a general formula (II): R⁴—O—{(EO)n¹/(PO)m¹}—H (II)
(in the general formula (II), R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement);
a nitrogen-containing nonionic surfactant (component C) represented by a general formula (III):

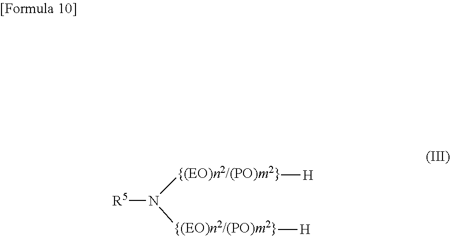

(in the general formula (III), R⁵ represents an alkyl group or a cycloalkyl group having 8 or more and 18 or less carbon atoms on average, EO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the EO added shown in { } is optionally a random arrangement or a block arrangement); and water (component D), the cleaning composition having a pH of 7.1 or more.

The cleaning composition for metal articles of the present embodiment has sufficient cleaning performance at ambient temperature and excellent drying properties at ambient temperature and thus can contribute to reducing the burden on the environment. The reason why the cleaning composition exhibits such an effect is not clear, but is presumed as follows.

If the pH of the cleaning composition is set to 7.1 or more (that is, alkaline) in the presence of the amine (component A), the cleaning effect of the cleaning composition can be enhanced while saponification of fats and oils is promoted. It is presumed that the cleaning composition permeates into a narrow gap or an internal corner of a metal article by the action of the nonionic surfactant (component B), the nitrogen-containing nonionic surfactant (component C), and the water (component D) and the cleaning composition can be efficiently brought into contact with an object to be cleaned to enhance the cleaning effect. Furthermore, it is presumed that combination of the nonionic surfactant (component B) and the nitrogen-containing nonionic surfactant (component C) makes the cleaning composition rapidly penetrate into and act on dirt adhering to the metal surface, particularly organic dirt, to reduce the surface tension and the viscosity and the dirt is incorporated into the cleaning composition from the metal surface and thus can be efficiently removed. Then, it is presumed that the interaction of the nonionic surfactant (component B), the nitrogen-containing nonionic surfactant (component C), and the water (component D) makes the cleaning composition exhibit high wettability to reduce the amount of adhering water remaining on the object to be cleaned after cleaning the dirt and thus the drying properties are enhanced.

### [Amine (Component A)]

The amine (component A) is represented by the general formula (I).

Examples of the amine (component A) include alkanolamines such as monoethanolamine, diethanolamine, and triethanolamine, and alkylated products and aminoalkylated products thereof. As the amine (component A), at least one selected from monoethanolamine, monoisopropanolamine, N-methylmonoethanolamine, N-methylmonoisopropanolamine, N-ethylmonoethanolamine, N-ethylmonoisopropanolamine, N-phenylmonoethanolamine, N-phenylmonoisopropanolamine, N-benzylmonoethanolamine, N-benzylmonoisopropanolamine, diethanolamine, diisopropanolamine, N-dimethylmonoethanolamine, N-dimethylmonoisopropanolamine, N-methyldiethanolamine, N-methyldiisopropanolamine, N-diethylmonoethanolamine, N-diethylmonoisopropanolamine, N-ethyldiethanolamine, N-ethyldiisopropanolamine, N-phenyldiethanolamine, N-phenyldiisopropanolamine, N-benzyldiethanolamine, N-benzyldiisopropanolamine, triethanolamine, N-(β-aminoethyl)monoethanolamine, N-(β-aminoethyl)monoisopropanolamine, N-(β-aminoethyl)diethanolamine, or N-(β-aminoethyl)diisopropanolamine is preferable, at least one selected from monoethanolamine, monoisopropanolamine, diethanolamine, N-methylmonoethanolamine, N-dimethylmonoethanolamine, N-ethylmonoethanolamine, N-methyldiethanolamine, triethanolamine, or N-(β-aminoethyl)monoethanolamine is more preferable, and at least one selected from diethanolamine or triethanolamine is further preferable from the viewpoint of improving the cleaning performance.

The content of the amine (component A) in the cleaning composition is preferably 0.01 mass % or more, more preferably 0.05 mass % or more, and further preferably 0.1 mass % or more from the viewpoint of improving the cleaning performance, and preferably 1.0 mass % or less, more preferably 0.7 mass % or less, and further preferably 0.5 mass % or less from the viewpoint of improving the cleaning performance and reducing the wastewater treatment load.

### [Nonionic Surfactant (Component B)]

The nonionic surfactant (component B) is represented by the general formula (II). The nonionic surfactant (component B) may be used singly or in combination of two or more kinds thereof.

In the general formula (II), R⁴ has 12 or more carbon atoms from the viewpoint of improving the cleaning performance at ambient temperature and improving the drying properties at ambient temperature, and has 16 or less carbon atoms from the same viewpoint. In the general formula (II), R⁴ is an alkyl group, and is preferably a secondary alkyl group from the viewpoint of improving the cleaning performance at ambient temperature and improving the drying properties at ambient temperature.

In the general formula (II), the ethyleneoxy group and the propyleneoxy group have distribution depending on the number of moles added, but from the viewpoint of improving the cleaning performance at ambient temperature and improving the drying properties at ambient temperature, the average number of moles of ethyleneoxy groups added n¹ is 2 or more, preferably 3 or more, more preferably 4 or more, and further preferably 5 or more, and from the same viewpoint, 20 or less, preferably 15 or less, more preferably 10 or less, and further preferably 8 or less. From the same viewpoint, the average number of moles of propyleneoxy groups added m¹ is 0 or more, and from the same viewpoint, 20 or less, preferably 10 or less, and more preferably less than 1. In the general formula (III), the average number of moles of ethyleneoxy groups added n¹ is preferably larger than the average number of moles of propyleneoxy groups added m¹ from the viewpoint of improving the cleaning performance.

The nonionic surfactant (component B) preferably has a hydrophile-lipophile balance value (HLB) determined by the Griffin method of 3.6 or more and 5.6 or less from the viewpoint of improving the cleaning performance at ambient temperature. In the case of using two or more kinds of the components (B), the weight average of the HLBs of the components (B) determined by the Griffin method is used as the HLB.

The content of the nonionic surfactant (component B) in the cleaning composition is preferably 0.001 mass % or more, more preferably 0.005 mass % or more, and further preferably 0.01 mass % or more from the viewpoint of improving the cleaning performance at ambient temperature and improving the drying properties at ambient temperature, and preferably 1.5 mass % or less, more preferably 0.5 mass % or less, and further preferably 0.2 mass % or less from the viewpoint of reducing the wastewater treatment load.

### [Nitrogen-Containing Nonionic Surfactant (Component C)]

The nitrogen-containing nonionic surfactant (component C) is represented by the general formula (III). The nitrogen-containing nonionic surfactant (component C) may be used singly or in combination of two or more kinds thereof.

In the general formula (III), R⁵ has 8 or more, and preferably 12 or more carbon atoms on average from the viewpoint of improving the cleaning performance at ambient temperature and improving the drying properties at ambient temperature, and has 18 or less, and preferably 16 or less carbon atoms on average from the same viewpoint. The nitrogen-containing nonionic surfactant (component C) can be used by mixing those having the average carbon number of R⁵ within the above range.

In the general formula (III), the ethyleneoxy group and the propyleneoxy group have distribution depending on the number of moles added, but from the viewpoint of improving the cleaning performance at ambient temperature and improving the drying properties at ambient temperature, the average number of moles of ethyleneoxy groups added n² is 1 or more, and preferably 1.5 or more, and from the same viewpoint, 8 or less, and preferably 4 or less. From the same viewpoint, the average number of moles of propyleneoxy groups added m² is 0 or more, and from the same viewpoint, 8 or less, and preferably 4 or less. In the general formula (III), the average number of moles of ethyleneoxy groups added n² is preferably larger than the average number of moles of propyleneoxy groups added m² from the viewpoint of improving the cleaning performance.

The content of the nitrogen-containing nonionic surfactant (component C) in the cleaning composition is preferably 0.001 mass % or more, more preferably 0.005 mass % or more, and further preferably 0.01 mass % or more from the viewpoint of improving the cleaning performance at ambient temperature and improving the drying properties at ambient temperature, and preferably 1.5 mass % or less, more preferably 0.5 mass % or less, and further preferably 0.2 mass % or less from the viewpoint of reducing the wastewater treatment load.

The mass ratio of the nonionic surfactant (component B) to the nitrogen-containing nonionic surfactant (component C) (the mass of the component B/the mass of the component C) in the cleaning composition is preferably 0.001 or more and 100 or less. The mass ratio of the nonionic surfactant (component B) to the nitrogen-containing nonionic surfactant (component C) is more preferably 0.01 or more, and further preferably 0.1 or more from the viewpoint of improving the cleaning performance, and more preferably 10 or less, further preferably 3 or less from the viewpoint of improving the drying properties.

### [Water (Component D)]

As the water (component D), industrial water, tap water, deionized water, and the like can be used. Industrial water is preferable from the viewpoint of supply property and cost and ion-exchanged water is preferable from the viewpoint of cleaning performance.

The content of water (component D) in the cleaning composition is preferably 75% by mass or more, more preferably 90% by mass or more, further preferably 98% by mass or more from the viewpoint of improving the cleaning performance, and is preferably 99.97% by mass or less, more preferably 99.6% by mass or less, further preferably 99.4% by mass or less from the same viewpoint.

The cleaning composition has a pH of 7.1 or more, and preferably 7.5 or more from the viewpoint of improving the cleaning performance. The upper limit of the pH of the cleaning composition is not particularly limited, but is generally 12 or less.

### [Other Components]

The cleaning composition may contain components other than the components A to D in a range in which the performance is not affected. Examples of the components other than the components A to D include a rust preventing agent, a defoaming agent, a preservative, a coloring agent, a solubilizer, a dispersant, and a thickening agent such as a thickener.

### [Rust Preventing Agent]

The rust preventing agent can be used without limitation as long as it prevents the formation of rust on metal articles. The rust preventing agent is preferably a dicarboxylic acid (component E) represented by the following general formula (IV). The dicarboxylic acid (component E) may be used singly or two or more thereof may be used concurrently.

The general formula (IV): HOOC—R⁶—COOH) (IV)

(In the general formula (IV), R⁶ is an alkylene group having 10 or more and 12 or less carbon atoms.)

Examples of the dicarboxylic acid (component E) include 1,10-decanedicarboxylic acid, 1,11-undecanedicarboxylic acid, and 1,12-dodecanedicarboxylic acid. The dicarboxylic acid (component E) is preferably 1,10-decanedicarboxylic acid from the viewpoint of improving the performance of suppressing corrosion of iron.

The dicarboxylic acid (component E) and the amine (component A) form a salt in water. Therefore, when the cleaning composition contains the dicarboxylic acid (component E), the cleaning composition substantially contains a salt (component E′) of the dicarboxylic acid (component E) and the amine (component A). The component E′ may be used singly or two or more thereof may be used concurrently. The cleaning composition may be prepared using the component E′ which has formed a salt in advance.

Examples of the component E′ include 1,10-decanedicarboxylic acid diethanolamine salt, 1,11-undecanedicarboxylic acid diethanolamine salt, 1,12-dodecanedicarboxylic acid diethanolamine salt, 1,10-decanedicarboxylic acid triethanolamine salt, 1,11-undecanedicarboxylic acid triethanolamine salt, and 1,12-dodecanedicarboxylic acid triethanolamine salt. The component E′ is preferably 1,10-decandicarboxylic acid diethanolamine salt and 1,10-decandicarboxylic acid triethanolamine salt from the viewpoint of improving the cleaning performance and the performance of suppressing corrosion of iron.

When the cleaning composition contains the component E′, the content of the component E′ in the cleaning composition is preferably 0.01% by mass or more, more preferably 0.05% by mass or more, and further preferably 0.1% by mass or more from the viewpoint of improving the performance of suppressing corrosion of iron and is preferably 1.2% by mass or less, more preferably 0.7% by mass or less, further preferably 0.5% by mass or less from the viewpoint of improving the cleaning performance and reducing the wastewater treatment load.

### [Defoaming Agent]

The cleaning composition preferably contains a defoaming agent from the viewpoint of suppressing the workability deterioration due to foaming and the cleaning liquid leaving loss. The defoaming agent is not particularly limited, and any defoaming agent can be used as long as it has a defoaming effect. Examples of the defoaming agent include a silicone-based defoaming agent and organic defoaming agents such as a polyether and a higher alcohol. It is desirable to use the defoaming agent in a small added amount in consideration of the influence on the cleaning performance, and a silicone-based defoaming agent is preferable. As the silicone-based defoaming agent, there are, for example, an oil type, an oil compound type, a solution type, an emulsion type, and a self-emulsifying type, and a self-emulsifying type is preferable from the viewpoint of improving the foam suppressing effect and of the storage stability of the cleaning composition.

The content of the defoaming agent in the cleaning composition is preferably 0 mass % or more and 5.0 mass % or less, more preferably 0 mass % or more and 2.0 mass % or less, further preferably 0 mass % or more and 1.0 mass % or less, and still further preferably 0 mass % or more and 0.5 mass % or less.

The cleaning composition can be produced by blending the respective components described above by a known method. The “blending” includes mixing the respective components described above at the same time or in an arbitrary order.

The cleaning composition may be prepared as a concentrate in which the amount of water of the component D is decreased in a range in which the storage stability is not impaired by the occurrence of separation, precipitation, and the like. The concentrate of the cleaning composition is preferably prepared as a concentrate having a dilution degree of 3 times or more from the viewpoint of transportation and storage and is preferably prepared as a concentrate having a dilution degree of 30 times or less from the viewpoint of storage stability. The concentrate of the cleaning composition can be used by being diluted with water so that the respective components have the above-mentioned contents at the time of use (namely, the contents at the time of cleaning). The concentrate of the cleaning composition can also be used by separately adding the respective components at the time of use. In the present disclosure, “at the time of use” or “at the time of cleaning” of the cleaning composition of the concentrate means a state in which the concentrate of the cleaning composition has been diluted.

### <Processing Oil Removing Composition for Metal Articles>

The cleaning composition may be a processing oil removing composition for metal articles (hereinafter, sometimes referred to as a removing composition) that is used for removal, from the metal article, of a processing oil that adheres to the metal article in production of the metal article. That is, the removing composition contains the component A, the component B, the component C, and the component D, and has a pH of 7.1 or more. For the same reason as the cleaning composition, the removing composition has a sufficient property of removing a processing oil at ambient temperature and excellent drying properties at ambient temperature and thus can contribute to reducing the burden on the environment.

### <Method of Cleaning a Metal Article>

The method for cleaning a metal article of the present embodiment includes a cleaning step of cleaning a metal article using the cleaning composition.

### [Cleaning Step]

The cleaning temperature in the cleaning step is preferably 80° C. or less, more preferably 70° C. or less, and further preferably 60° C. or less from the viewpoint of reducing the energy cost and the burden on the environment. The cleaning composition has sufficient cleaning performance at ambient temperature, and therefore the cleaning temperature may be 30° C. or less. From the viewpoint of cleaning performance, the cleaning temperature is preferably 10° C. or more, and more preferably 20° C. or more.

The cleaning time in the cleaning step is difficult to determine unconditionally due to the influence of the cleaning temperature and the like, but is generally preferably 0.5 seconds or more, more preferably 1 second or more, and further preferably 5 seconds or more from the viewpoint of improving the cleaning performance, and preferably 100 seconds or less, and more preferably 60 seconds or less from the viewpoint of improving the productivity.

Examples of the cleaning method in the cleaning step include continuous cleaning, namely, immersion cleaning, spray cleaning, brush cleaning, and ultrasonic cleaning. It is possible to clean and remove oil stains such as cutting oil and ATF oil adhered during the processing and storage period of single metal part and the assembly of metal articles and solid stains such as dust and processing debris. The method of cleaning in the cleaning step is preferably immersion and spray cleaning, more preferably spray cleaning, and spray cleaning is suitably applied when a metal article passes through a cleaning tank by a belt conveyor or a roller conveyor.

In the spray cleaning, the spray pressure at the time of spray cleaning is preferably 0.1 MPa or more, more preferably 0.2 MPa or more and preferably 5 MPa or less, more preferably 1 MPa or less.

After the cleaning step, a rinsing step of rinsing the cleaned metal article with water or the like can be provided. However, rinsing removes the cleaning composition from the surface of the metal article, and thus the drying properties at ambient temperature and the performance of suppressing corrosion of iron may deteriorate. Therefore, no rinsing is preferably performed after the cleaning step. That is, the cleaning composition can be used as a non-rinse type cleaning composition for metal articles.

### [Drying Step]

The method of cleaning may include a drying step of drying the metal article having a surface to which an excess of the cleaning composition is adhered, after the cleaning step.

The drying temperature in the drying step is preferably 100° C. or less, more preferably 90° C. or less, and further preferably 80° C. or less from the viewpoint of reducing the energy cost and the burden on the environment. The cleaning composition has excellent drying properties at ambient temperature, and therefore the drying temperature may be 30° C. or less. From the viewpoint of improving the productivity, the drying temperature is preferably 10° C. or more, and more preferably 20° C. or more.

The drying step may be a drying step of removing an excess of the cleaning composition from the metal article by air purging or the like and drying the metal article. In this case, the temperature of the air blowing is preferably 20° C. or more, more preferably 30° C. or more, and further preferably 40° C. or more from the viewpoint of improving the productivity, and preferably 100° C. or less, more preferably 90° C. or less, and further preferably 80° C. or less from the viewpoint of reducing the energy cost and the burden on the environment.

The metal article that can be cleaned with the cleaning composition is not particularly limited, and examples of the metal article include metal products and metal parts that are used as raw materials for transportation machinery such as automobiles, bicycles, railroads, ships, and airplanes, home appliances such as televisions, air conditioners, and refrigerators, electronic devices such as mobile terminals and computers, tableware, and beverage cans.

<Method of Removing Processing Oil from Metal Article>

According to the method of cleaning, it is possible to remove a processing oil that adheres to the metal article in production of the metal article. Therefore, the method of cleaning may be a method of removing a processing oil. The method of removing a processing oil of the present embodiment includes a removal step of removing, from the metal article, a processing oil that adheres to the metal article in production of the metal article, using the removing composition. A preferable aspect of the removal step is the same as a preferable aspect of the cleaning step in the method of cleaning a metal article, and therefore description of a preferable aspect of the removal step is omitted. A preferable aspect of the method of removing a processing oil is the same as a preferable aspect of the method of cleaning a metal article, and therefore description of a preferable aspect of the method of removing a processing oil is omitted.

In relation to the above-described embodiment, the present description further discloses the following compositions, etc.

<1>

A cleaning composition for metal articles including:
an amine (component A) represented by a general formula (I):

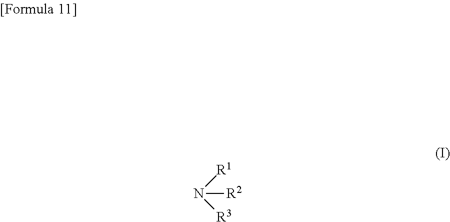

wherein R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group;
a nonionic surfactant (component B) represented by
a general formula (II): R⁴—O—{(EO)n¹/(PO)m¹}—H (II)
wherein R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement;
a nitrogen-containing nonionic surfactant (component C) represented by a general formula (III):

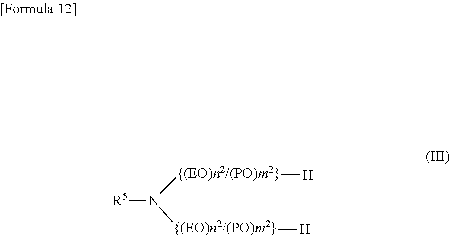

wherein R⁵ represents an alkyl group or a cycloalkyl group having 8 or more and 18 or less carbon atoms on average, EO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the EO added shown in { } is optionally a random arrangement or a block arrangement; and
water (component D),
the cleaning composition having a pH of 7.1 or more.
   <2>

The cleaning composition for metal articles according to <1>, wherein the component B has a hydrophile-lipophile balance value (HLB) determined by a Griffin method of 3.6 or more and 5.6 or less.

<3>

The cleaning composition for metal articles according to <1> or <2>, wherein in the general formula (II), R⁴ is a secondary alkyl group having 12 or more and 16 or less carbon atoms.

<4>

The cleaning composition for metal articles according to any one of <1> to <3>, wherein a content of the component A is 0.01 mass % or more and 1.0 mass % or less.

<5>

The cleaning composition for metal articles according to any one of <1> to <4>, wherein a content of the component B is 0.001 mass % or more and 1.5 mass % or less.

<6>

The cleaning composition for metal articles according to any one of <1> to <5>, wherein a content of the component C is 0.001 mass % or more and 1.5 mass % or less.

<7>

The cleaning composition for metal articles according to any one of <1> to <6>, including a dicarboxylic acid (component E) represented by
a general formula (IV): HOOC—R⁶—COOH) (IV)
wherein R⁶ represents an alkylene group having 10 or more and 12 or less carbon atoms.
   <8>

The cleaning composition for metal articles according to any one of <1> to <7>, including a salt (component E′) of a dicarboxylic acid (component E) represented by
a general formula (IV): HOOC—R⁶—COOH) (IV)
wherein R⁶ represents an alkylene group having 10 or more and 12 or less carbon atoms
with the amine (component A).
   <9>

The cleaning composition for metal articles according to any one of <1> to <8>, wherein a mass ratio of the component B to the component C (a mass of the component B/a mass of the component C) is 0.001 or more and 100 or less.

<10>

The cleaning composition for metal articles according to any one of <1> to <9>, including a defoaming agent.

<11>

The cleaning composition for metal articles according to any one of <1> to <10>, wherein a content of the water is 75 mass % or more and 99.97 mass % or less.

<12>

A method of cleaning a metal article, the method including a cleaning step of cleaning a metal article using the cleaning composition for metal articles according to any one of <1> to <11>.

<13>

The method of cleaning a metal article according to <12>, wherein a cleaning temperature in the cleaning step is 10° C. or more and 30° C. or less.

<14>

The method of cleaning a metal article according to <12> or <13>, including a drying step after the cleaning step, the drying step of drying the metal article having a surface to which the cleaning composition for metal articles is adhered.

<15>

The method of cleaning a metal article according to <14>, wherein in the drying step, the metal article is dried while an excess of the cleaning composition for metal articles that is adhered to the metal article is removed by air blowing.

<16>

The method of cleaning a metal article according to <14> or <15>, wherein a drying temperature in the drying step is 10° C. or more and 30° C. or less.

<17>

A processing oil removing composition for metal articles including:
an amine (component A) represented by a general formula (I):

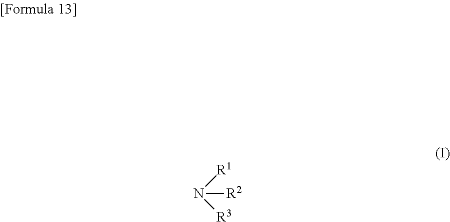

wherein R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group;

a nonionic surfactant (component B) represented by
a general formula (II): R⁴—O—{(EO)n¹/(PO)m¹}—H (II)
wherein R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement;
a nitrogen-containing nonionic surfactant (component C) represented by a general formula (III):

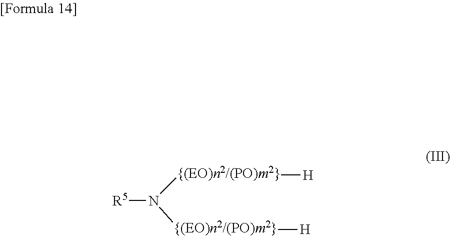

wherein R⁵ represents an alkyl group or a cycloalkyl group having 8 or more and 18 or less carbon atoms on average, EO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the EO added shown in { } is optionally a random arrangement or a block arrangement; and
water (component D),
the processing oil removing composition having a pH of 7.1 or more.
   <18>

A method of removing a processing oil from a metal article, the method including a removal step of removing a processing oil from a metal article, the processing oil that adheres to the metal article in production of the metal article, using the processing oil removing composition for metal articles according to <17>.

<20>

Use of a composition for removal of a processing oil for metal articles,
wherein the composition contains
an amine (component A) represented by a general formula (I):

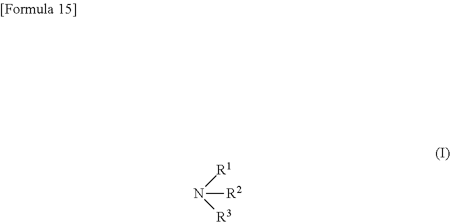

wherein R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group;
a nonionic surfactant (component B) represented by
a general formula (II): R⁴—O—{(EO)n¹/(PO)m¹}—H (II)
wherein R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement;
a nitrogen-containing nonionic surfactant (component C) represented by a general formula (III):

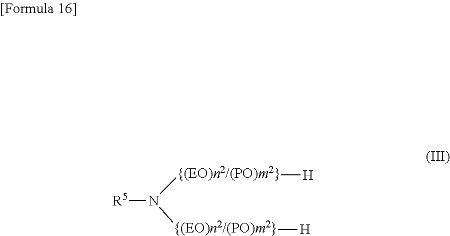

wherein R⁵ represents an alkyl group or a cycloalkyl group having 8 or more and 18 or less carbon atoms on average, EO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the EO added shown in { } is optionally a random arrangement or a block arrangement; and
water (component D),
the composition having a pH of 7.1 or more.

### Examples

Hereinafter, the present invention will be described in more detail by way of Examples, but the present invention is not limited to these Examples at all.

### <Preparation of Cleaning Composition>

The cleaning compositions of Examples 1 to 31 and Comparative Examples 1 to 14 were each prepared in an amount of 300 g with the following procedure so that the contents of the cleaning compositions were as described in Tables 1 to 3. The numerical values described in Tables 1 to 3 each show the amount of an active component, and the unit is mass %. The HLB values described in Tables 1 to 3 were determined by calculation with the Griffin method.

### [Preparation Procedure]

1. In a 300 ml glass beaker, an alkaline agent (component A) and water (component D) were mixed and stirred to obtain a mixed liquid.
2. To the mixed liquid obtained in 1 above, a nonionic surfactant (component B) and a nitrogen-containing nonionic surfactant (component C), and in addition, in a case where another component was added, the component were added, and the mixture was mixed and stirred to obtain a cleaning composition for metal articles according to each of Examples and Comparative Examples.

The following components were used as the components described in Tables 1 to 3.

### Component a (Amine Represented by Formula (I))

A1: Diethanolamine (manufactured by FUJIFILM Wako Pure Chemical Corporation, diethanolamine (DEA))
A2: Triethanolamine (manufactured by Kishida Chemical Co., Ltd., 2,2′,2″-nitrilotriethanol)
A3: N-methyldiethanolamine (manufactured by Tokyo Chemical Industry Co., Ltd., 2-hydroxyethyl(methylamino)ethanol)
A4: N-methylethanolamine (manufactured by Tokyo Chemical Industry Co., Ltd., 2-(methylamino) ethanol)

### Component B

B1: Polyethylene glycol (2) lauryl ether [manufactured by Kao Corporation]

The number in ( ) represents the average number of moles added. The same applies hereinafter.
B2: Polyethylene glycol (4) lauryl ether [manufactured by Kao Corporation]
B3: Polyethylene glycol (5) lauryl ether [manufactured by Kao Corporation]
B4: Polyethylene glycol (6) lauryl ether [manufactured by Kao Corporation]
B5: Polyethylene glycol (6.5) tridecyl ether [manufactured by AOKI OIL INDUSTRIAL Co., Ltd., FINESURF TD-65]
B6: Polyethylene glycol (8) tridecyl ether [manufactured by AOKI OIL INDUSTRIAL Co., Ltd., FINESURF TD-80]
B7: Surfactant B7 obtained by the following method

An autoclave was charged with polyethylene glycol (7) alkyl (secondary dodecyl and secondary tetradecyl mixed) ether (1 mol, “SOFTANOL 70” manufactured by NIPPON SHOKUBAI CO., LTD.) and a catalytic amount of potassium hydroxide (manufactured by NACALAI TESQUE, INC.), nitrogen purging was performed, then dehydration was performed under reduced pressure to set the water content in the system to 0.2% or less, propylene oxide (4.5 mol) was added at 125° C. at 0.3 MPa or less, and aging was performed to obtain an EO-PO adduct (surfactant B7).
B8: Surfactant B8 obtained by the following method

An autoclave was charged with polyethylene glycol (7) alkyl (secondary dodecyl and secondary tetradecyl mixed) ether (1 mol, “SOFTANOL 70” manufactured by NIPPON SHOKUBAI CO., LTD.) and a catalytic amount of potassium hydroxide (manufactured by NACALAI TESQUE, INC.), nitrogen purging was performed, then dehydration was performed under reduced pressure to set the water content in the system to 0.2% or less, propylene oxide (8.5 mol) was added at 125° C. at 0.3 MPa or less, and aging was performed to obtain an EO-PO adduct (surfactant B8).
B9: Surfactant B9 obtained by the following method

An autoclave was charged with polyethylene glycol (9) alkyl (secondary dodecyl and secondary tetradecyl mixed) ether (1 mol, “SOFTANOL 90” manufactured by NIPPON SHOKUBAI CO., LTD.) and a catalytic amount of potassium hydroxide (manufactured by NACALAI TESQUE, INC.), nitrogen purging was performed, then dehydration was performed under reduced pressure to set the water content in the system to 0.2% or less, propylene oxide (5.0 mol) was added at 125° C. at 0.3 MPa or less, and aging was performed to obtain an EO-PO adduct (surfactant B9).
B10: Surfactant B10 obtained by the following method

An autoclave was charged with polyethylene glycol (9) alkyl (secondary dodecyl and secondary tetradecyl mixed) ether (1 mol, “SOFTANOL 90” manufactured by NIPPON SHOKUBAI CO., LTD.) and a catalytic amount of potassium hydroxide (manufactured by NACALAI TESQUE, INC.), nitrogen purging was performed, then dehydration was performed under reduced pressure to set the water content in the system to 0.2% or less, propylene oxide (15 mol) was added at 125° C. at 0.3 MPa or less, and aging was performed to obtain an EO-PO adduct (surfactant B10).
B11: Polyethylene glycol (8) cetyl ether [manufactured by AOKI OIL INDUSTRIAL Co., Ltd., BLAUNON CH-308]
B12: Polyethylene glycol (2) 2-ethylhexyl ether [manufactured by AOKI OIL INDUSTRIAL Co., Ltd., BLAUNON EH-2]
B13: Polyethylene glycol (6) 2-ethylhexyl ether [manufactured by AOKI OIL INDUSTRIAL Co., Ltd., BLAUNON EH-6]
B14: Polyethylene glycol (11) 2-ethylhexyl ether [manufactured by AOKI OIL INDUSTRIAL Co., Ltd., BLAUNON EH-11]
B15: Polyethylene glycol (4) decyl (Guerbet) ether [manufactured by BASF SE, Lutensol XL40]
B16: Polyethylene glycol (8) decyl (Guerbet) ether [manufactured by BASF SE, Lutensol XL80]
B17: Polyethylene glycol (11) stearyl ether [manufactured by AOKI OIL INDUSTRIAL Co., Ltd., BLAUNON SR-711]

### Component C

C1: Polyoxyethylene lauryl amine, average number of moles of oxyethylene groups added: 2.1, manufactured by Kao Corporation
C2: Polyoxyethylene lauryl amine, average number of moles of oxyethylene groups added: 4.2, manufactured by Kao Corporation

### Component D (Water)

Ion-exchange water: pure water with 1 μS/cm or less manufactured by water purifier G-10DSTSET manufactured by ORGANO CORPORATION

### Component E

1,10-Decanedicarboxylic acid (manufactured by Tokyo Chemical Industry Co., Ltd.)

### Defoaming Agent

Tridecanol (manufactured by KH Neochem Co., Ltd.)

### <Evaluation Method>

### [pH of Cleaning Composition]

The pH was the pH of the cleaning composition at 25° C. determined by measuring the numerical value 3 minutes after immersion of the electrode of a pH meter (HM-30G manufactured by DKK-TOA CORPORATION) in the cleaning composition.

### [Cleaning Test]

About 0.1 g of a processing oil was added dropwise to SPCC (50×20×0.8 mm) degreased and cleaned with acetone, and the SPCC was allowed to stand for 1 hour. The weight of the SPCC before dropping of the processing oil and the weight of the sample after dropping of the processing oil and allowing to stand for 1 hour were measured to determine the weight of the adhered oil before cleaning. The sample was cleaned with the cleaning composition according to each of Examples and Comparative Examples at room temperature (25° C.) at 0.1 Mpa for 10 seconds using a shower cleaning apparatus, and dried in a thermostatic chamber at 50° C. for about 15 minutes to obtain a substrate after cleaning. The cleaning rate was calculated with the following equation. It can be said that the larger this value is, the more excellent the cleaning performance is.

Cleaning rate=(amount of oil adhered to sample before cleaning [g]−amount of oil adhered to sample after cleaning [g])/amount of oil adhered to sample before cleaning [g]×100

### [Measurement of Contact Angle]

SPCC (dimensions: 50×20×0.8 mm) was degreased and cleaned with acetone, and then dried by air blowing. Then, the contact angle of the cleaning composition according to each of Examples and Comparative Examples with respect to the SPCC after 20 seconds was measured using DMo-501 manufactured by Kyowa Interface Science Co., Ltd. The smaller the contact angle is, the higher the wettability is, the less the amount of the residual water after cleaning is, and the more the liquid-draining property is improved, and therefore a smaller contact angle indicates excellent drying properties. If the contact angle is 10° or less, it can be said that the drying properties at ambient temperature are excellent, and therefore the contact angle was used in the evaluation criteria.

### [Drying Test]

SPCC (dimensions: 50×20×0.8 mm) was degreased and cleaned with acetone, and then dried by air blowing. Then, the SPCC was immersed in the cleaning composition according to each of Examples and Comparative Examples at room temperature (25° C.) for 20 seconds, then taken out, and allowed to stand on a plate stand. The time was measured until the front upper part (50%) area was dried in the SPCC allowed to stand on the plate stand at room temperature (25° C.). The shorter the time is, the more excellent the drying properties are, and if the time was 140 seconds or less, the drying properties at ambient temperature were regarded to be excellent.

Tables 1 to 3 show the evaluation results.

TABLE 1

| | | Average | Average | Average | | | | | | | |
|---|---|---|---|---|---|---|---|---|---|---|---|
| | | number of | number of | number of | | | | | | | |
| | | carbon | moles of | moles of | | Example | | | | | |
| | | atoms | EO added | PO added | HLB | 1 | 2 | 3 | 4 | 5 | 6 |
| Compo- | Diethanol- | | | | | 0.16 | | 0.16 | 0.16 | 0.16 | 0.16 |
| nent A | amine (DEA) | | | | | | | | | | |
| | Triethanol- | | | | | | 0.27 | | | | |
| | amine (TEA) | | | | | | | | | | |
| Compo- | B1 | 12 | 2 | | 3.9 | 0.1 | 0.1 | | | | |
| nent B | B2 | 12 | 4 | | 4.5 | | | 0.1 | | | |
| | B3 | 12 | 5 | | 4.9 | | | | 0.1 | | |
| | B4 | 12 | 6 | | 5.2 | | | | | 0.1 | |
| | TD-65 | 13 | 6.5 | | 4.9 | | | | | | 0.1 |
| | TD-80 | 13 | 8 | | 5.4 | | | | | | |
| | B7 | 12 | 7 | 4.5 | 4.8 | | | | | | |
| | B8 | 12 | 7 | 8.5 | 4.2 | | | | | | |
| | B9 | 12 | 9 | 5 | 5.4 | | | | | | |
| | B10 | 12 | 9 | 15 | 3.9 | | | | | | |
| | CH-308 | 16 | 8 | | 3.9 | | | | | | |
| Compo- | C1 | | | | | 0.1 | 0.1 | 0.1 | 0.1 | 0.1 | 0.1 |
| nent C | C2 | | | | | | | | | | |
| Compo- | Water | | | | | 99.64 | 99.53 | 99.64 | 99.64 | 99.64 | 99.64 |
| nent D | | | | | | | | | | | |
| Compo- | 1,10-Decanedi- | | | | | 0.26 | | 0.26 | 0.26 | 0.26 | 0.26 |
| nent E′ | carboxylic | | | | | | | | | | |
| | acid DEA salt | | | | | | | | | | |
| | 1,10-Decanedi- | | | | | | 0.31 | | | | |
| | carboxylic | | | | | | | | | | |
| | acid TEA salt | | | | | | | | | | |
| Another | Defoaming | | | | | | | | | | |
| component | agent | | | | | | | | | | |
| Mass of component B/ | | | | | | 1 | 1 | 1 | 1 | 1 | 1 |
| mass of component C | | | | | | | | | | | |
| pH (25° C.) | | | | | | 9.29 | 8.06 | 9.24 | 9.3 | 9.21 | 9.25 |
| Cleaning | Cleaning | | | | | 83 | 83 | 82 | 82 | 70 | 78 |
| test | rate | | | | | | | | | | |
| | [%] | | | | | | | | | | |
| Measurement | Contact | | | | | 7.5 | 6.7 | 3.2 | 2.8 | 5.5 | 3.5 |
| of contact | angle after | | | | | | | | | | |
| angle | 20 seconds | | | | | | | | | | |
| | [°] | | | | | | | | | | |
| Drying test | Time to | | | | | 131 | 126 | 116 | 113 | 124 | 117 |
| at 25° C. | drying | | | | | | | | | | |
| | [sec] | | | | | | | | | | |

| | | Example | | | | | | | | |
|---|---|---|---|---|---|---|---|---|---|---|
| | | 7 | 8 | 9 | 10 | 11 | 12 | 13 | 14 | 15 |
| Compo- | Diethanol- | 0.16 | 0.16 | 0.16 | 0.16 | 0.16 | 0.16 | 0.16 | | 0.16 |
| nent A | amine (DEA) | | | | | | | | | |
| | Triethanol- | | | | | | | | 0.27 | |
| | amine (TEA) | | | | | | | | | |
| Compo- | B1 | | | | | | | 0.1 | 0.1 | |
| nent B | B2 | | | | | | | | | 0.1 |
| | B3 | | | | | | | | | |
| | B4 | | | | | | | | | |
| | TD-65 | | | | | | | | | |
| | TD-80 | 0.1 | | | | | | | | |
| | B7 | | 0.1 | | | | | | | |
| | B8 | | | 0.1 | | | | | | |
| | B9 | | | | 0.1 | | | | | |
| | B10 | | | | | 0.1 | | | | |
| | CH-308 | | | | | | 0.1 | | | |
| Compo- | C1 | 0.1 | 0.1 | 0.1 | 0.1 | 0.1 | 0.1 | | | |
| nent C | C2 | | | | | | | 0.1 | 0.1 | 0.1 |
| Compo- | Water | 99.64 | 99.64 | 99.64 | 99.42 | 99.64 | 99.64 | 99.64 | 99.53 | 99.64 |
| nent D | | | | | | | | | | |
| Compo- | 1,10-Decanedi- | 0.26 | 0.26 | 0.26 | 0.26 | 0.26 | 0.26 | 0.26 | | 0.26 |
| nent E′ | carboxylic | | | | | | | | | |
| | acid DEA salt | | | | | | | | | |
| | 1,10-Decanedi- | | | | | | | | 0.31 | |
| | carboxylic | | | | | | | | | |
| | acid TEA salt | | | | | | | | | |
| Another | Defoaming | | | | 0.23 | | | | | |
| component | agent | | | | | | | | | |
| Mass of component B/ | | 1 | 1 | 1 | 1 | 1 | 1 | 1 | 1 | 1 |
| mass of component C | | | | | | | | | | |
| pH (25° C.) | | 9.25 | 9.23 | 9.21 | 9.31 | 9.28 | 9.25 | 9.21 | 8.15 | 9.19 |
| Cleaning | Cleaning | 70 | 89 | 91 | 88 | 87 | 78 | 84 | 82 | 79 |
| test | rate | | | | | | | | | |
| | [%] | | | | | | | | | |
| Measurement | Contact | 1.7 | 2.8 | 6.8 | 7.2 | 9 | 9.9 | 3.2 | 2.8 | 5.1 |
| of contact | angle after | | | | | | | | | |
| angle | 20 seconds | | | | | | | | | |
| | [°] | | | | | | | | | |
| Drying test | Time to | 109 | 113 | 126 | 129 | 135 | 139 | 114 | 127 | 120 |
| at 25° C. | drying | | | | | | | | | |
| | [sec] | | | | | | | | | |

TABLE 2

| | | Average | Average | Average | | | | | | | |
|---|---|---|---|---|---|---|---|---|---|---|---|
| | | number of | number of | number of | | | | | | | |
| | | carbon | moles of | moles of | | Example | | | | | |
| | | atoms | EO added | PO added | HLB | 16 | 17 | 18 | 19 | 20 | 21 |
| Compo- | Diethanol- | | | | | 0.16 | 0.16 | 0.16 | | | |
| nent A | amine (DEA) | | | | | | | | | | |
| | Triethanol- | | | | | | | | | | |
| | amine (TEA) | | | | | | | | | | |
| | N-methyldi- | | | | | | | | 0.17 | 0.17 | 0.17 |
| | ethanolamine | | | | | | | | | | |
| | N-methyl- | | | | | | | | | | |
| | ethanolamine | | | | | | | | | | |
| Compo- | B1 | 12 | 2 | | 3.9 | | | | | | |
| nent B | TD-65 | 13 | 6.5 | | 4.9 | 0.1 | | | | | |
| | B7 | 12 | 7 | 4.5 | 4.8 | | | | 0.1 | | |
| | B8 | 12 | 7 | 8.5 | 4.2 | | 0.1 | | | 0.1 | |
| | B9 | 12 | 9 | 5 | 5.4 | | | | | | 0.1 |
| | B10 | 12 | 9 | 15 | 3.9 | | | 0.1 | | | |
| | CH-308 | 16 | 8 | | 3.9 | | | | | | |
| Compo- | C1 | | | | | | | | 0.1 | 0.1 | 0.1 |
| nent C | C2 | | | | | 0.1 | 0.1 | 0.1 | | | |
| Compo- | Water | | | | | 99.64 | 99.64 | 99.64 | 99.63 | 99.63 | 99.63 |
| nent D | | | | | | | | | | | |
| Compo- | 1,10-Decanedi- | | | | | 0.26 | 0.26 | 0.26 | | | |
| nent E′ | carboxylic | | | | | | | | | | |
| | acid DEA salt | | | | | | | | | | |
| Mass of component B/ | | | | | | 1 | 1 | 1 | 1 | 1 | 1 |
| mass of component C | | | | | | | | | | | |
| pH (25° C.) | | | | | | 9.15 | 9.09 | 9.15 | 10.64 | 10.71 | 10.66 |
| Cleaning | Cleaning | | | | | 77 | 85 | 88 | 91 | 90 | 93 |
| test | rate | | | | | | | | | | |
| | [%] | | | | | | | | | | |
| Measurement | Contact | | | | | 2.7 | 9.9 | 4.8 | 2.5 | 4.7 | 6.7 |
| of contact | angle after | | | | | | | | | | |
| angle | 20 seconds | | | | | | | | | | |
| | [°] | | | | | | | | | | |
| Drying test | Time to | | | | | 110 | 139 | 118 | 111 | 119 | 126 |
| at 25° C. | drying | | | | | | | | | | |
| | [sec] | | | | | | | | | | |

| | | Example | | | | | | | | | |
|---|---|---|---|---|---|---|---|---|---|---|---|
| | | 22 | 23 | 24 | 25 | 26 | 27 | 28 | 29 | 30 | 31 |
| Compo- | Diethanol- | | | | 0.16 | 0.16 | 0.16 | | | | |
| nent A | amine (DEA) | | | | | | | | | | |
| | Triethanol- | | | | | | | 0.27 | 0.27 | 0.27 | 0.27 |
| | amine (TEA) | | | | | | | | | | |
| | N-methyldi- | | | | | | | | | | |
| | ethanolamine | | | | | | | | | | |
| | N-methyl- | 0.12 | 0.12 | 0.12 | | | | | | | |
| | ethanolamine | | | | | | | | | | |
| Compo- | B1 | | | | 0.1 | 0.25 | 0.5 | 0.025 | 0.1 | 0.3 | 0.6 |
| nent B | TD-65 | | | | | | | | | | |
| | B7 | | | | | | | | | | |
| | B8 | | 0.1 | | | | | | | | |
| | B9 | | | | | | | | | | |
| | B10 | 0.1 | | 0.1 | | | | | | | |
| | CH-308 | | | | | | | | | | |
| Compo- | C1 | 0.1 | | | 0.1 | 0.25 | 0.5 | 0.2 | 0.2 | 0.2 | 0.2 |
| nent C | C2 | | 0.1 | 0.1 | | | | | | | |
| Compo- | Water | 99.68 | 99.68 | 99.68 | 99.64 | 99.34 | 98.84 | 99.51 | 99.43 | 99.23 | 98.93 |
| nent D | | | | | | | | | | | |
| Compo- | 1,10-Decanedi- | | | | | | | | | | |
| nent E′ | carboxylic | | | | | | | | | | |
| | acid DEA salt | | | | | | | | | | |
| Mass of component B/ | | 1 | 1 | 1 | 1 | 1 | 1 | 0.125 | 0.5 | 1.5 | 3 |
| mass of component C | | | | | | | | | | | |
| pH (25° C.) | | 11.3 | 11.21 | 11.17 | | | | | | | |
| Cleaning | Cleaning | 89 | 89 | 91 | 84 | 83 | 85 | 84 | 82 | 84 | 83 |
| test | rate | | | | | | | | | | |
| | [%] | | | | | | | | | | |
| Measurement | Contact | 8.4 | 8.5 | 4.9 | 5.6 | 5.9 | 6.1 | 5.9 | 5.8 | 5.7 | 5.8 |
| of contact | angle after | | | | | | | | | | |
| angle | 20 seconds | | | | | | | | | | |
| | [°] | | | | | | | | | | |
| Drying test | Time to | 133 | 131 | 119 | 125 | 125 | 126 | 127 | 126 | 126 | 125 |
| at 25° C. | drying | | | | | | | | | | |
| | [sec] | | | | | | | | | | |

TABLE 3

| | | Average | Average | Average | | | | | | |
|---|---|---|---|---|---|---|---|---|---|---|
| | | number of | number of | number of | | | | | | |
| | | carbon | moles of | moles of | | Comparative Example | | | | |
| | | atoms | EO added | PO added | HLB | 1 | 2 | 3 | 4 | 5 |
| Compo- | Diethanol- | | | | | 0.16 | 0.16 | 0.16 | 0.16 | 0.16 |
| nent A | amine (DEA) | | | | | | | | | |
| Nonionic | B3 | 12 | 5 | | 4.9 | | 0.2 | | | |
| surfactant | B4 | 12 | 6 | | 5.2 | | | 0.2 | | |
| | B9 | 12 | 9 | 5 | 5.4 | | | | 0.2 | |
| | B10 | 12 | 9 | 15 | 3.9 | | | | | 0.2 |
| | EH-2 | 8 | 2 | | 5.8 | | | | | |
| | EH-6 | 8 | 6 | | 7.1 | | | | | |
| | EH-11 | 8 | 11 | | 8.7 | | | | | |
| | Lutensol | 10 | 4 | | 5.5 | | | | | |
| | XL-40 | | | | | | | | | |
| | Lutensol | 10 | 8 | | 6.8 | | | | | |
| | XL-80 | | | | | | | | | |
| | SR-711 | 18 | 11 | | 4.0 | | | | | |
| Compo- | C1 | | | | | 0.2 | | | | |
| nent C | | | | | | | | | | |
| Compo- | Water | | | | | 99.64 | 99.64 | 99.64 | 99.64 | 99.64 |
| nent D | | | | | | | | | | |
| Compo- | 1,10-Decanedi- | | | | | 0.26 | 0.26 | 0.26 | 0.26 | 0.26 |
| nent E′ | carboxylic | | | | | | | | | |
| | acid DEA salt | | | | | | | | | |
| Mass of component B/ | | | | | | — | — | — | — | — |
| mass of component C | | | | | | | | | | |
| pH (25° C.) | | | | | | 9.21 | 9.23 | 9.18 | 9.29 | 9.23 |
| Cleaning | Cleaning | | | | | 35 | 14 | 22 | 24 | 15 |
| test | rate | | | | | | | | | |
| | [%] | | | | | | | | | |
| Measurement | Contact | | | | | 20.8 | 6.7 | 11.2 | 21.1 | 19.1 |
| of contact | angle after | | | | | | | | | |
| angle | 20 seconds | | | | | | | | | |
| | [°] | | | | | | | | | |
| Drying test | Time to | | | | | 176 | 130 | 142 | 171 | 184 |
| at 25° C. | drying | | | | | | | | | |
| | [sec] | | | | | | | | | |

| | | Comparative Example | | | | | | | | |
|---|---|---|---|---|---|---|---|---|---|---|
| | | 6 | 7 | 8 | 9 | 10 | 11 | 12 | 13 | 14 |
| Compo- | Diethanol- | 0.16 | 0.16 | 0.16 | 0.16 | 0.16 | 0.16 | 0.16 | 0.16 | |
| nent A | amine (DEA) | | | | | | | | | |
| Nonionic | B3 | | | | | | | | | 0.1 |
| surfactant | B4 | | | | | | | | | |
| | B9 | | | | | | | | | |
| | B10 | | | | | | | | | |
| | EH-2 | 0.1 | | | | | | | | |
| | EH-6 | | 0.1 | | | | | | | |
| | EH-11 | | | 0.1 | | | | | | |
| | Lutensol | | | | 0.1 | | | 0.2 | | |
| | XL-40 | | | | | | | | | |
| | Lutensol | | | | | 0.1 | | | 0.2 | |
| | XL-80 | | | | | | | | | |
| | SR-711 | | | | | | 0.1 | | | |
| Compo- | C1 | 0.1 | 0.1 | 0.1 | 0.1 | 0.1 | 0.1 | | | 0.1 |
| nent C | | | | | | | | | | |
| Compo- | Water | 99.64 | 99.64 | 99.64 | 99.64 | 99.64 | 99.64 | 99.64 | 99.64 | 99.80 |
| nent D | | | | | | | | | | |
| Compo- | 1,10-Decanedi- | 0.26 | 0.26 | 0.26 | 0.26 | 0.26 | 0.26 | 0.26 | 0.26 | |
| nent E′ | carboxylic | | | | | | | | | |
| | acid DEA salt | | | | | | | | | |
| Mass of component B/ | | 1 | 1 | 1 | 1 | 1 | 1 | — | — | 1 |
| mass of component C | | | | | | | | | | |
| pH (25° C.) | | 9.22 | 9.24 | 9.25 | 9.23 | 9.23 | 9.21 | 9.17 | 9.21 | 6.96 |
| Cleaning | Cleaning | 2 | 12 | 22 | 20 | 35 | 77 | 31 | 28 | 2 |
| test | rate | | | | | | | | | |
| | [%] | | | | | | | | | |
| Measurement | Contact | 8.4 | 10.4 | 14.6 | 2.4 | 6.9 | 15.4 | 4.5 | 10.1 | 5.5 |
| of contact | angle after | | | | | | | | | |
| angle | 20 seconds | | | | | | | | | |
| | [°] | | | | | | | | | |
| Drying test | Time to | 134 | 145 | 157 | 113 | 127 | 159 | 119 | 141 | 122 |
| at 25° C. | drying | | | | | | | | | |
| | [sec] | | | | | | | | | |

1-15. (canceled)

16. A method of cleaning a metal article, the method comprising a cleaning step of cleaning a metal article using a cleaning composition for metal articles comprising:
an amine (component A) represented by a general formula (I): 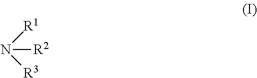
wherein R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group;
a nonionic surfactant (component B) represented by
a general formula (II): R⁴—O—{(EO)n¹/(PO)m¹}—H (II)
wherein R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement;
a nitrogen-containing nonionic surfactant (component C) represented by a general formula (III): 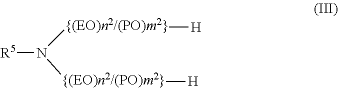
wherein R⁵ represents an alkyl group or a cycloalkyl group having 8 or more and 18 or less carbon atoms on average, EO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the BO added shown in { } is optionally a random arrangement or a block arrangement; and
water (component D),
the cleaning composition having a pH of 7.1 or more,
wherein a mass ratio of the component B to the component C (a mass of the component B/a mass of the component C) is 0.001 or more and 100 or less.

17. The method of cleaning a metal article according to claim 16, wherein the component B has a hydrophile-lipophile balance value (HLB) determined by a Griffin method of 3.6 or more and 5.6 or less.

18. The method of cleaning a metal article according to claim 16, wherein in the general formula (II), R⁴ is a secondary alkyl group having 12 or more and 16 or less carbon atoms.

19. The method of cleaning a metal article according to claim 16, wherein a content of the component A is 0.01 mass % or more and 1.0 mass % or less, a content of the component B is 0.001 mass % or more and 1.5 mass % or less, and a content of the component C is 0.001 mass % or more and 1.5 mass % or less.

20. The method of cleaning a metal article according to claim 16, comprising a salt (component E′) of a dicarboxylic acid (component E) represented by
a general formula (IV): HOOC—R⁶—COOH) (IV)
wherein Re represents an alkylene group having 10 or more and 12 or less carbon atoms with the amine (component A).

21. The method of cleaning a metal article according to claim 16, wherein a mass ratio of the component B to the component C (a mass of the component B/a mass of the component C) is 0.01 or more and 10 or less.

22. The method of cleaning a metal article according to claim 16, comprising a defoaming agent.

23. The method of cleaning a metal article according to claim 16, wherein a content of the water is 75 mass % or more and 99.97 mass % or less.

24. The method of cleaning a metal article according to claim 16, wherein a cleaning temperature in the cleaning step is 10° C. or more and 30° C. or less.

25. The method of cleaning a metal article according to claim 16, comprising a drying step after the cleaning step, the drying step of drying the metal article having a surface to which the cleaning composition for metal articles is adhered.

26. The method of cleaning a metal article according to claim 16, wherein in the drying step, the metal article is dried while an excess of the cleaning composition for metal articles that is adhered to the metal article is removed by air blowing.

27. The method of cleaning a metal article according to claim 16, wherein a drying temperature in the drying step is 10° C. or more and 30° C. or less.

28. A cleaning composition for metal articles comprising:
an amine (component A) represented by a general formula (I): 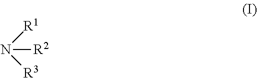
wherein R¹ and R² each independently represent a hydrogen atom, an alkyl group having 1 or more and 6 or less carbon atoms, a phenyl group, a benzyl group, an aminoethyl group, a hydroxyethyl group, or a hydroxypropyl group and R³ represents a hydroxyethyl group or a hydroxypropyl group;
a nonionic surfactant (component B) represented by
a general formula (II): R⁴—O—{(EO)n¹/(PO)m¹}—H (II)
wherein R⁴ represents an alkyl group having 12 or more and 16 or less carbon atoms, EO represents an ethyleneoxy group, PO represents a propyleneoxy group, n¹ represents an average number of moles of EO added, m¹ represents an average number of moles of PO added, n¹ is a number of 2 or more and 20 or less, m¹ is a number of 0 or more and 20 or less, and a form of the PO added and the EO added shown in { } is optionally a random arrangement or a block arrangement;
a nitrogen-containing nonionic surfactant (component C) represented by a general formula (III): 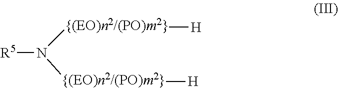
wherein R⁵ represents an alkyl group or a cycloalkyl group having 8 or more and 18 or less carbon atoms on average, BO represents an ethyleneoxy group, PO represents a propyleneoxy group, n² represents an average number of moles of EO added, m² represents an average number of moles of PO added, n² is a number of 1 or more and 8 or less, m² is a number of 0 or more and 8 or less, and a form of the PO added and the EO added shown in { } is optionally a random arrangement or a block arrangement; and
water (component D),
the cleaning composition having a pH of 7.1 or more,
wherein a mass ratio of the component B to the component C (a mass of the component B/a mass of the component C) is 0.001 or more and 100 or less.
